(19) United States
(12) Patent Application Publication
(10) Pub. No.: US 2015/0015495 A1
(43) Pub. Date: Jan. 15, 2015

(54) DYNAMIC MOBILE DISPLAY GEOMETRY TO ACCOMMODATE GRIP OCCLUSION

(71) Applicant: International Business Machines Corporation, Armonk, NY (US)

(72) Inventors: CHANDRASEKHAR NARAYANASWAMI, WILTON, CT (US); UMUT TOPKARA, SCARSDALE, NY (US)

(21) Appl. No.: 13/940,975

(22) Filed: Jul. 12, 2013

(51) Int. Cl. G06F 3/041

(52) U.S. Cl. CPC G06F 3/0412
USPC 345/173

(57) ABSTRACT

Systems and methods for occlusion accommodation include identifying grasped regions on a display of a device due to a user's grasp of the device. Occluded regions on the display are determined based on the grasped regions. Content on the display is adjusted by deactivating touch events in the occluded regions to accommodate the display for occlusions from the user's grasp.

### BACKGROUND

1. Technical Field

The present invention relates to mobile devices, and more particularly to dynamic display geometry to accommodate grip occlusion in mobile devices.

2. Description of the Related Art

Current handheld mobile devices, such as mobile phones and tablets, have displays covering most of their front face. These displays are typically touch-enabled to allow users to interact with the devices through slight touches and gestures to the display area. While this direct interaction has helped users to more easily learn to use touch-enabled mobile devices, it has also created a big burden on the users. To avoid accidentally touching the touch-enabled display or to obtain a better view of the displayed content, users typically hold the device with a light grip on the edges. In this manner, users avoid occluding the display with their fingers. However, in the usage setting where users are even mildly mobile (standing in the subway, standing in line, etc.), the light grip of the user may result in accidentally dropping and damaging the device.

### SUMMARY

A method for occlusion accommodation includes identifying grasped regions on a display of a device due to a user's grasp of the device. Occluded regions on the display are determined based on the grasped regions. Content on the display is adjusted by deactivating touch events in the occluded regions to accommodate the display for occlusions from the user's grasp.

A system for occlusion accommodation includes a grasp determination module configured to identify grasped regions on a display of a device due to a user's grasp of the device. An occlusion determination module is configured to determine occluded regions on the display based on the grasped regions. An adjustment module is configured to adjust content on the display by deactivating touch events in the occluded regions to accommodate the display for occlusions from the user's grasp.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 shows a mobile device having grip occlusions, in accordance with one illustrative embodiment;

FIG. 2 is a block/flow diagram of a system/method for dynamic display rendering, in accordance with one illustrative embodiment;

FIG. 3 shows a mobile device having content adjusted by resizing, in accordance with one illustrative embodiment;

FIG. 4 shows a mobile device having content adjusted by graphically shearing, in accordance with one illustrative embodiment; and

FIG. 5 is a block/flow diagram of a system/method for dynamic display rendering, in accordance with one illustrative embodiment.

### DETAILED DESCRIPTION OF PREFERRED EMBODIMENTS

Embodiments of the present invention provide for a system and method for dynamic mobile display geometry to accommodate grip occlusion. In general, users may need to touch the touch-enabled display of a mobile device, such as, e.g., a mobile phone or tablet, not as part of interacting with the device, but to securely hold the device. These touches are different from interactive touches. Interactive touches are usually short taps or active swipe gestures, whereas touches as a result of a user's grip or grasp are relatively static and last for a longer period of time.

The present invention first determines grasped regions on the touch-enabled display. Grasped regions may be determined based on at least one of a length of contact time, area of contact, and user inputted gesture. Occluded regions are then determined from the grasped regions. Occluded regions may be preset by a user, such that preset occluded regions that overlap the grasped regions are identified as the occluded regions. Occluded regions may also be adaptively determined to identify the grasped regions as the occluded regions. Content of the touch-enabled display is then adjusted based on the occluded regions. Adjusting content may include deactivating touch events in the occluded regions. Adjusting content may further include at least one of resizing the content, displaying the content as being wrapped around the occluded regions, and graphically shearing the content.

One advantage of the present invention is that content is adjusted for occluded regions of a touch-enabled displaying, allowing a user to securely hold or grasp the mobile device.

As will be appreciated by one skilled in the art, aspects of the present invention may be embodied as a system, method or computer program product. Accordingly, aspects of the present invention may take the form of an entirely hardware embodiment or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

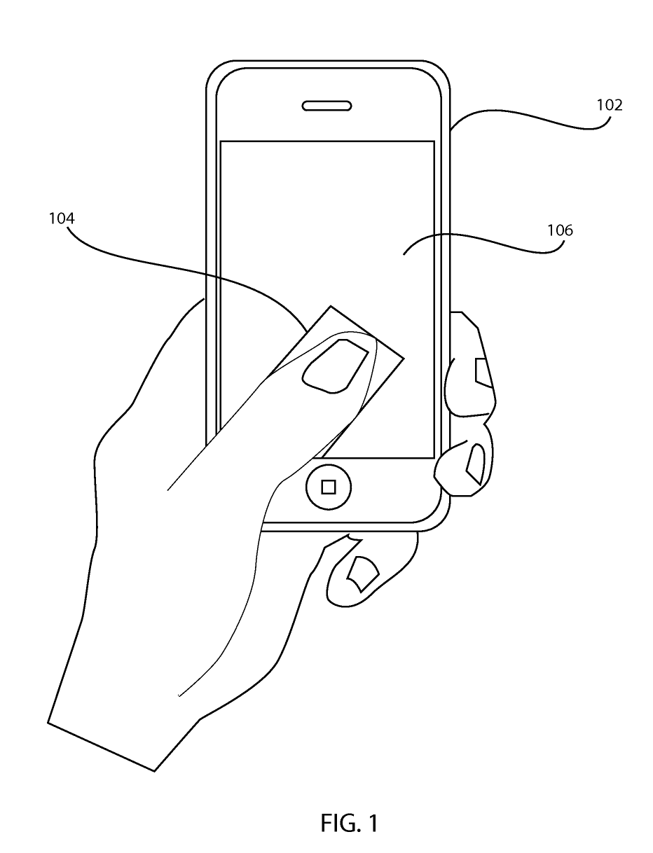

Referring now to the drawings in which like numerals represent the same or similar elements and initially to FIG. 1, a mobile device having grip occlusions 100 is shown in accordance with one illustrative embodiment. A mobile device 102 preferably includes a touch-enabled display. To securely hold the mobile device 102, users typically grip the mobile device 102 in a manner that occludes a portion of the touch-enabled display. This results in occluded area 104 and visible area 106 of the touch-enabled display. If the mobile device 102 does not account for the user's grip, it may cause the user to hold the device 102 in an unsecure manner.

The present invention embraces the fact that users may need to touch the interactive touch-enabled display not as part of interacting with the device, but simply to hold or grip the device in a secure manner. Touches as a result of a user's grip are different from interactive touches in that interactive touches are typically short taps or active swipe gestures, whereas touches as a result of a grip are relatively static and last for a longer period of time. Naturally, the user's fingers and/or palm occlude a portion of the touch-enabled display during this time.

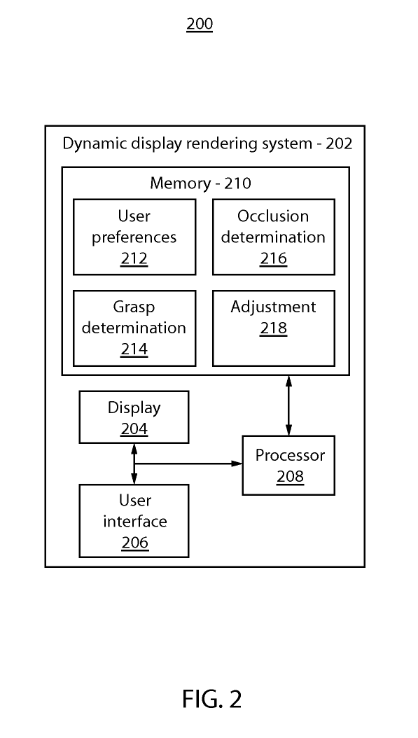

Referring now to FIG. 2, a block/flow diagram showing a dynamic display rendering system 200 is depicted in accordance with one illustrative embodiment. The system 200 may adjust for occlusions on a touch-enabled display due to a user's grip.

The system 200 may include a system or workstation 202. The system 202 may include, in part or in whole, any device having a touch-enabled display, such as, e.g., a mobile phone, a tablet, a global positioning system (GPS) device, a watch, a camera, a personal digital assistant, etc. The system 202 preferably includes one or more processors 208 and memory 210 for storing applications, modules and other data. The system 202 may also include one or more displays 204 for viewing. The displays 204 may permit a user to interact with the system 204 and its components and functions. This may be further facilitated by a user interface 206, which may include a mouse, joystick, touch-enabled display, or any other peripheral or control to permit user interaction with the system 202 and/or its devices. It should be understood that the components and functions of the system 202 may be integrated into one or more systems or workstations, or may be incorporated as part of a larger system or workstation.

It should be understood that embodiments of the present invention may be applied in a number of different applications. For example, the present invention may be discussed throughout this application as a mobile device having a touch-enabled display. However, it should be understood that the present invention is not so limited. Rather, embodiments of the present invention may be applicable to any device having a display that may be occluded. For example, one embodiment of the present invention may be employed to adjust for occlusions in front of a projector, such as, e.g., due to a presenter. The present invention may detect a presenter using, e.g., a camera or other sensor and mask the occluded area to prevent the projector from shining into the presenter's eyes and adjust the projected content such that the content is displayed in the non-occluded portions. Other applications may also be applied within the context of the present invention.

The memory 210 may store user preferences 212 of the system 202. User preferences 212 may include whether occlusion adjustment is enabled or disabled. Occlusion adjustment may be enabled or disabled manually by a user or automatically by the system 202 based on data from one or more sensors (e.g., GPS, accelerometer, gyroscope, camera, microphone, infrared sensors, touch sensors, radio-frequency identification sensors, near field communication sensors, Bluetooth™, Wi-Fi™, etc.) of the system 202. Using sensor data, occlusion accommodation may be enabled or disabled based on location, placement, time, event, user, etc. Events may include the opening of an app, continuous shaking motions identified from the sensor data, switching user profiles, etc.

The grasp determination module 214 is configured to determine grasped regions of the touch-enabled display of the system 202. The grasp may be detected at the operating system level or at the application level of the system 202. The grasp determination module 214 preferably determines whether and where the system 202 is grasped based on a length of time and/or the area of contact of the touch-enabled display. In one embodiment, a single touch or multiple touches longer than a predefined length of time may indicate a user's grasp on the touch-enabled display. In another embodiment, the touch contact area larger than a predefined area (e.g., when the touch contact area is too large to be an interactive touch with just fingertips) may indicate a user's grasp on the touch-enabled display. In still another embodiment, a user may manually indicate that the display is grasped. For example, a user may apply a pattern or gesture (e.g., a rubbing gesture) to the touch-enabled display. Other forms of grasp detection are also contemplated. The grasp determination module 214 identifies the grasped regions as the touch contact regions where a grasp is detected.

Occlusion determination module 216 is configured to determine the regions of the touch-enabled display that are to be occluded based on the grasped regions. In one embodiment, the occluded regions are preset by a user and stored in user preferences 212. If a grasped region overlaps a preset occluded region, the preset occluded region may be used. The user may be given options of different preset occluded regions based on the grasped region or may be given an option to ignore preset occluded region. In another embodiment, adaptive occluded region detection may be employed to identify the grasped regions as the occluded regions.

Adjustment module 218 is configured to adjust displayed content of the system 202 based on the occluded regions. The adjustment module 218 deactivates touch events in the occluded regions. As a result, touch events in the occluded regions will not be considered by the application and/or operating system as interactive touches and, hence will not be included in touch or swipe gestures.

Occluded regions also define the areas that will not be visible to the user, since the grasping fingers will occlude the display in those regions. There are several options that the adjustment module 218 may employ to handle this occlusion information. The adjustment module 218 may ignore the occluded region and let the user deal with the occluded region. This may include notifying the user that content may not be visible. The adjustment module 218 may also adjust the rendering of the content so that the occluded regions do not occlude content. Adjusting may include resizing the content and/or displaying the content wrapped around the occluded regions. Adjusting may also include graphically shearing the content to display the content as if it were physically lifted. In another embodiment, the user is able to switch grip locations without adjusting content. In this case, the adjustment module 218 deactivates touch events in the occluded regions, but does not adjust the content displayed.

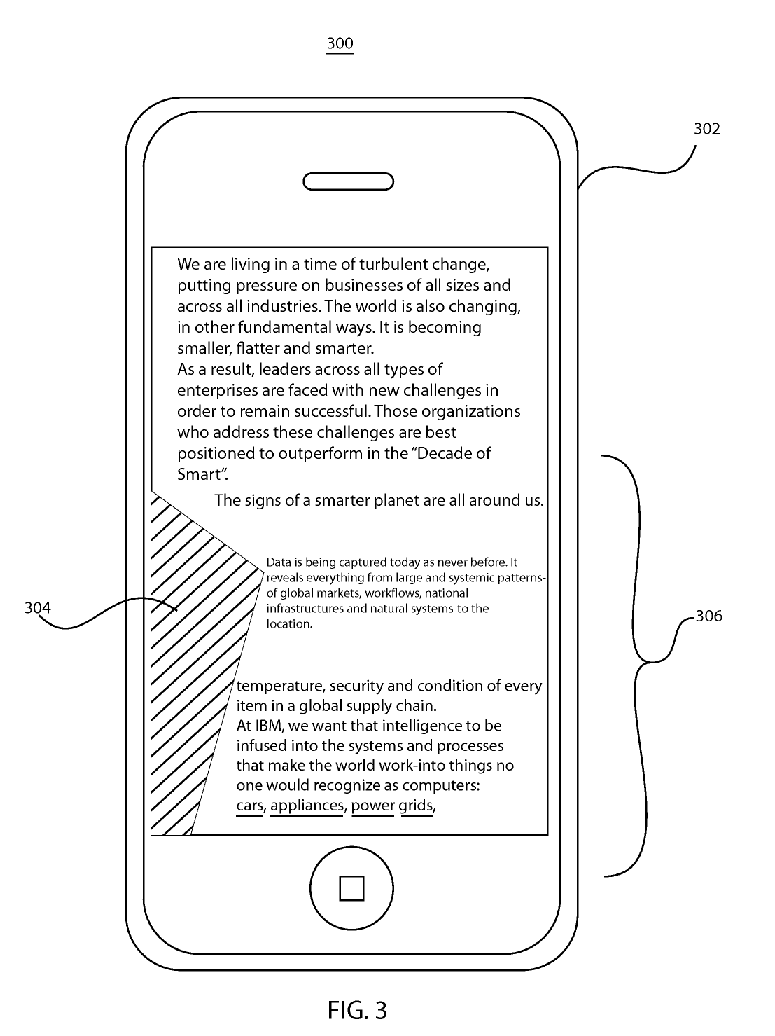

Referring for a moment to FIG. 3, with continued reference to FIG. 2, content is adjusted by resizing 300, in accordance with one illustrative embodiment. A mobile device 302 includes a touch-enabled display having occluded regions 304 preferably due to a user's grip. The adjustment module 218 adjusts content 306 due to the occluded regions 304. The adjusted content 306 is reduced in size and wrapped around the occluded regions 304.

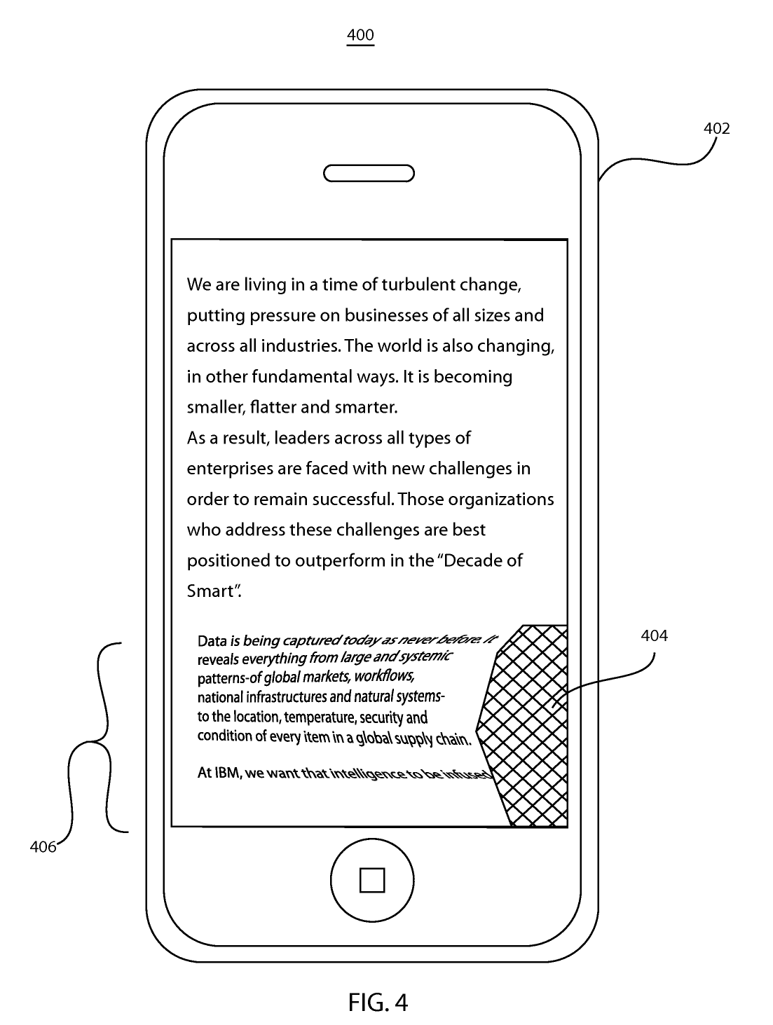

Referring for a moment to FIG. 4, with continued reference to FIG. 2, content is adjusted by graphically shearing 400, in accordance with one illustrative embodiment. A mobile device 402 includes a touch-enabled display having occluded regions 404 preferably due to a user's grip. The adjustment module 218 adjusts content 406 due to the occluded regions 404. The adjusted content 406 is graphically sheared to give the impression that the content 406 is physically lifted or peeled around the occluded regions 404.

Referring back to FIG. 2, the adjustment module 218 may automatically suggest (or predict) a grip or a tighter grip, which would be identified as occluded areas. The suggested grips may be stored as preset occluded regions in user preferences 212. The adjustment module 218 preferably notifies the user of the suggested grip. Notifying the user may include employing an indicator, such as, e.g., flashing alternate colors where the suggested grip is located. Other forms of indicating may also be employed. The suggested grip may be automatically suggested based on location, placement, time, event, user, etc. using sensor data and other information of the system 202. For example, applications of the system 202 may be associated with one or more suggested grips. In one embodiment, multiple suggested grips may be presented to the user and the user can manually select a suggested grip.

An important consideration in rendering the grasped regions is how the content will be displayed during scrolling. Unless special attention is given to provide a predictable path for the content, the user might lose track of the reading position during the scrolling since the horizontal and vertical dimensions of the display are no longer consistent throughout the vertical and horizontal scrolling path. The adjustment module 218 adjusts for scrolling by uniformly resizing each line with a smaller font as the width gets smaller (e.g., due to the occluded regions), or by using a graphical projection effect.

Grasped regions should be comfortable for the user to securely hold their device. Over time, it is possible that muscle fatigue, movements of the user and changes in the environment (such as the direction and intensity of the light source) may call for changes in the way that the user grasps the device. This may cause the user to switch the grasping hand, change the location of the grasp or gradually shift the location of the grasp. The system 202 may account for changes in the user's grasp. The grasp detection module 214 continuously monitors changes the user's grasp. If the change is large enough (e.g., based on a predefined or user defined threshold), a new occlusion region is determined by occlusion detection module 216. The occlusion region may be a preset occlusion region or an adaptive occlusion region. The user may be given an option to change rendering based on the new occlusion region. If a new occlusion region is selected, the adjustment module 218 will adjust the display of content accordingly.

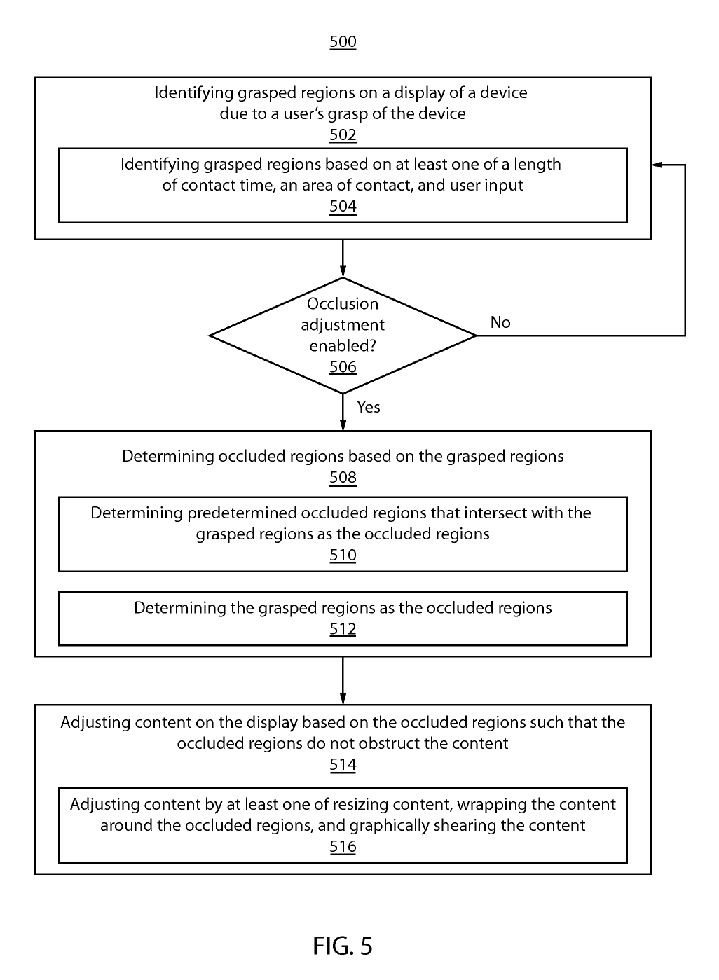

Referring now to FIG. 5, a block/flow diagram showing a method 500 for dynamic display rendering, in accordance with one illustrative embodiment. In block 502, grasped regions of a display on a device are identified due to a user's grasp of the device. The display is preferably a touch-enabled display on a mobile device. In block 504, grasped regions are identified based on at least one of a length of contact time, an area of contact, and user input. In one embodiment, grasped regions are identified where the contact time is longer than a predefined time. In another embodiment, grasped regions are identified where the area of the grasped regions are larger than a predefined area. In still another embodiment, user input may indicate grasped regions, such as, e.g., due to a rubbing gesture.

In block 506, it is determined whether occlusion adjustment is enabled. If no, the method returns to block 502. If yes, the method proceeds to block 508. Occlusion adjustment may be enabled or disabled manually by a user or automatically based on location, placement, time, event, user, etc. using sensor data.

In block 508, occluded regions are determined based on the grasped regions. In one embodiment, in block 510, predetermined or preset occluded regions that intersect with one or more grasped regions are determined as the occluded regions. The predetermined occluded regions may include a plurality of predetermine occluded regions that a user may select. In another embodiment, in block 512, the grasped regions are determined as the occluded regions.

In block 514, the rendering of the content on the display is adjusted based on the occluded regions such that the occluded regions do not obstruct the content. Adjusting preferably includes deactivating touch events in the occluded regions. Adjusting may further include automatically suggesting or predicting occluded regions based on location, placement, time, event, user, etc. In block 516, adjusting the rendering of the content is performed by at least one of resizing content, wrapping the content around the occluded regions, and graphically shearing the content. Resizing content may include uniformly resizing each line with a smaller font according to a non-occluded width of the display. Graphically shearing the content may include displaying the content to look physically lifted or peeled around the occluded regions. In one embodiment, adjusting includes deactivating touch events in occluded regions, but not adjusting the rendering of the content. Other forms of adjusting content are also contemplated.

Having described preferred embodiments of a system and method for dynamic mobile display geometry to accommodate grip occlusion (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. A method for occlusion accommodation, comprising:
identifying grasped regions on a display of a device due to a user's grasp of the device;
determining occluded regions on the display based on the grasped regions; and
adjusting content on the display by deactivating touch events in the occluded regions to accommodate the display for occlusions from the user's grasp.

2. The method as recited in claim 1, wherein identifying includes identifying areas of the display in contact with a user's grasp as the grasped regions based upon a threshold time.

3. The method as recited in claim 1, wherein identifying includes identifying areas of the display in contact with a user's grasp as the grasped regions based upon an area threshold.

4. The method as recited in claim 1, wherein identifying includes identifying areas of the display in contact with a user's grasp as the grasped regions based upon a gesture of the user.

5. The method as recited in claim 1, wherein determining occluded regions includes determining a predetermined occluded region that intersects with the grasped regions.

6. The method as recited in claim 1, wherein determining occluded regions includes determining the grasped regions as the occluded regions.

7. The method as recited in claim 1, wherein adjusting content includes at least one of resizing content, wrapping content around the occluded regions, and graphically shearing the content.

8. The method as recited in claim 1, wherein adjusting content includes adjusting content based upon at least one of location, placement, time, event, and user.

9. The method as recited in claim 1, wherein adjusting content includes adjusting content based upon sensor data.

10. The method as recited in claim 1, wherein the device is a mobile device.

11. A computer readable storage medium comprising a computer readable program for occlusion accommodation, wherein the computer readable program when executed on a computer causes the computer to perform the steps of:
identifying grasped regions on a display of a device due to a user's grasp of the device;
determining occluded regions on the display based on the grasped regions; and
adjusting content on the display by deactivating touch events in the occluded regions to accommodate the display for occlusions from the user's grasp.

12. A system for occlusion accommodation, comprising:
a grasp determination module configured to identify grasped regions on a display of a device due to a user's grasp of the device;
an occlusion determination module configured to determine occluded regions on the display based on the grasped regions; and
an adjustment module configured to adjust content on the display by deactivating touch events in the occluded regions to accommodate the display for occlusions from the user's grasp.

13. The system as recited in claim 12, wherein the grasp determination module is further configured to identify areas of the display in contact with a user's grasp as the grasped regions based upon a threshold time.

14. The system as recited in claim 12, wherein the grasp determination module is further configured to identify areas of the display in contact with a user's grasp as the grasped regions based upon an area threshold.

15. The system as recited in claim 12, wherein the grasp determination module is further configured to identify areas of the display in contact with a user's grasp as the grasped regions based upon a gesture of the user.

16. The system as recited in claim 12, wherein the occlusion determination module is further configured to determine a predetermined occluded region that intersects with the grasped regions.

17. The system as recited in claim 12, wherein the occlusion determination module is further configured to determine the grasped regions as the occluded regions.

18. The system as recited in claim 12, wherein the adjustment module is further configured to at least one of resize content, wrap content around the occluded regions, and graphically shear the content.

19. The system as recited in claim 12, wherein the adjustment module is further configured to adjust content based upon at least one of location, placement, time, event, and user.

20. The system as recited in claim 12, wherein the adjustment module is further configured to adjust content based upon sensor data.
